(19) United States
(12) Patent Application Publication
(10) Pub. No.: US 2008/0156277 A1
(43) Pub. Date: Jul. 3, 2008

(54) Animal Training Device Using a Vibration Probe to Deliver a Vibration Stimulus to an Animal

(75) Inventors: Christopher E. Mainini, Knoxville, TN (US); Keith Griffith, Oneida, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/619,452

(22) Filed: Jan. 3, 2007

(51) Int. Cl. A01K 15/02

(52) U.S. Cl. 119/718; 119/719; 119/720

(57) ABSTRACT

Described is a vibration stimulus delivery device for delivering a vibration stimulus to an animal by way of a vibration probe secured in physical contact with the skin of the animal. The vibration stimulus delivery device includes a vibration probe, a stimulus trigger detection device, and a carrying device. The vibration probe and the stimulus trigger detection device are secured to the carrying device, which is secured to the animal such that the animal carries the vibration probe and the stimulus trigger detection device. The vibration probe is disposed on the carrying device such that the vibration probe is secured in physical contact with the skin of the animal. The stimulus trigger detection device is adapted to detect an undesirable behavior and is in electrical communication with the vibration probe such that when the stimulus trigger detection device detects the undesirable behavior, the vibration probe is activated. When activated, the vibration probe generates a vibration.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to an animal training device for delivering a vibration stimulus to an animal. More particularly, this invention pertains to an animal training device for delivering a vibration stimulus to the animal by way of a vibration probe that is in physical contact with the skin of the animal.

2. Description of the Related Art

Many animal training systems include a vibration stimulus device for delivering a vibration stimulus to an animal. Studies have revealed that animals respond to a vibration stimulus used either as a primary deterrent or as a warning stimulus that is followed by a more intense deterrent, such as an electrical stimulus. Whether a vibration stimulus is effective as a deterrent or merely a warning stimulus depends on factors such as the breed, personality, sensitivity, and coat type of the animal. Additionally, a vibration stimulus may be effectively used as the primary deterrent of an animal training system for a period of time, but cease to be effective when the animal overcomes the initial startling effect of the vibration stimulus and discovers that the vibration stimulus does not trigger the animal's sensation of pain. This process is known as habituation. When the animal becomes accustomed to a vibration stimulus by way of habituation or the animal does not respond to a vibration stimulus as a primary deterrent, a more intense stimulus, such as an electrical stimulus, must be used to discourage the animal's undesirable behavior.

When a vibration stimulus can be used in the stead of a more intense stimulus, such as an electrical stimulus, it is desired. The preference for a vibration stimulus is because many pet owners view more intense stimuli, such as an electrical stimulus, as harmful or inhumane to the animal. Consequently, pet owners prefer a vibration stimulus over an electrical stimulus. Additionally, particular animals are hypersensitive to the extent that an intense stimulus, such as an electrical stimulus, would unnecessarily distress the animal both physically and psychologically. However, conventional vibration stimulus devices have been unable to provide a vibration stimulus effective enough to replace a more intense stimulus, such as an electrical stimulus, in accordance with the reasons discussed above. Conventional vibration stimulus devices include a vibration source disposed within a housing. The housing is typically a box-type structure that is mounted at the outside face of a pet collar, that is the housing is mounted to the face of the pet collar that is not in contact with the animal wearing the collar. These conventional devices are designed to generate a vibration in response to an undesirable behavior exhibited by the animal. However, these devices are limited in that the generated vibration is not contained or focused toward to the animal. Instead, a significant portion of the generated vibration is lost because the housing is not secured against the animal, but is vibrating freely at the outside face of the pet collar. Additionally, conventional devices are limited in that the generated vibration must be transferred from the housing, through the pet collar, through the animal's fur, and to the animal's skin. Consequently, the generated vibration is dampened by the housing, the pet collar, and the animal's fur, reducing the effectiveness of the vibration stimulus. As a result, a vibration stimulus device that is effective to the extent of being a primary deterrent, or otherwise replacing more intense stimuli, must be secured in direct contact with the animal's skin.

### BRIEF SUMMARY OF THE INVENTION

In accordance with the various features of the present invention there is provided a vibration stimulus delivery device for delivering a vibration stimulus to an animal by way of a vibration probe secured in physical contact with the skin of the animal. The vibration stimulus delivery device includes a vibration probe, a stimulus trigger detection device, and a carrying device. The vibration probe and the stimulus trigger detection device are secured to the carrying device, which includes a pet collar or pet harness. The carrying device is secured to the animal such that the animal carries the vibration probe and the stimulus trigger detection device. The vibration probe is disposed on the carrying device such that when the carrying device is secured to the animal, the vibration probe is secured in physical contact with the skin of the animal. The stimulus trigger detection device is responsive to a stimulus trigger. A stimulus trigger includes a signal generated by an animal training system or an undesirable behavior exhibited by the animal, such as a barking. For example, the stimulus trigger detection device includes a receiver adapted to communicate with an electronic pet confinement system. The stimulus trigger detection device is in electrical communication with the vibration probe such that when the stimulus trigger detection device responds to a stimulus trigger, the vibration probe is activated. When activated, the vibration probe generates a vibration. Because the vibration probe is secured in physical contact with the skin of the animal, the vibration generated by the vibration probe provides an effective vibration stimulus to the animal.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment the vibration probe device in accordance with the various features of the present invention;

FIG. 2 illustrates the vibration probe device of FIG. 1 secured in physical contact with the skin of the animal in accordance with the various features of the present invention;

FIG. 3 is an alternative embodiment of the vibration probe device illustrating the vibration probe and the stimulus trigger detection device as a single structure;

FIG. 4 is an exploded view of the vibration probe in accordance with the various features of the present invention;

FIG. 5 is an alternative embodiment of the vibration probe including a motor disposed outside the vibration probe;

FIG. 6 is an alternative embodiment of the vibration probe including a single motor driving multiple vibration probes;

FIG. 7 illustrates one embodiment of the gearbox of the alternative embodiment of the vibration probe illustrated in FIG. 6;

FIG. 8 is an alternative embodiment of the vibration probe whereby the vibration generated by the vibration probe has a direction that is perpendicular to the skin of the animal;

FIG. 9 illustrates one embodiment of the gearbox of the alternative embodiment of the vibration probe illustrated in FIG. 8; and

FIG. 10 is a block diagram illustrating the operation of one embodiment of the vibration probe device.

### DETAILED DESCRIPTION OF THE INVENTION

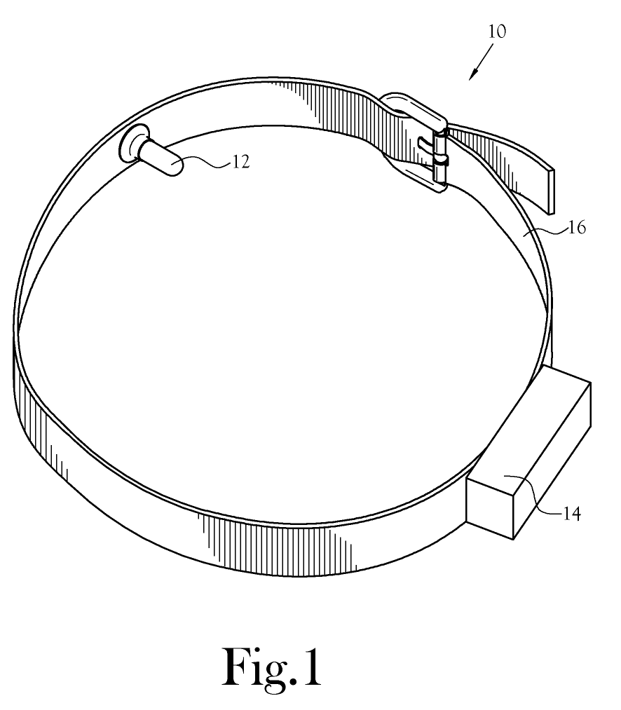

One embodiment of a vibration stimulus delivery device for delivering a vibration stimulus to an animal by way of a vibration probe secured in physical contact with the skin of the animal and constructed in accordance with the various features of the present invention is illustrated generally at 10 in FIG. 1. The vibration stimulus delivery device 10 includes a vibration probe, a stimulus trigger detection device, and a carrying device. The vibration probe and the stimulus trigger detection device are secured to the carrying device, which includes a pet collar or pet harness. The carrying device is secured to the animal such that the animal carries the vibration probe and the stimulus trigger detection device. The vibration probe is disposed on the carrying device such that when the carrying device is secured to the animal, the vibration probe is secured in physical contact with the skin of the animal. The stimulus trigger detection device is responsive to a stimulus trigger. A stimulus trigger includes a signal generated by an animal training system or an undesirable behavior exhibited by the animal, such as barking. For example, the stimulus trigger detection device includes a receiver adapted to communicate with an electronic pet confinement system. The stimulus trigger detection device is in electrical communication with the vibration probe such that when the stimulus trigger detection device responds to a stimulus trigger, the vibration probe is activated. When activated, the vibration probe generates a vibration. Because the vibration probe is secured in physical contact with the skin of the animal, the vibration generated by the vibration probe provides an effective vibration stimulus to the animal.

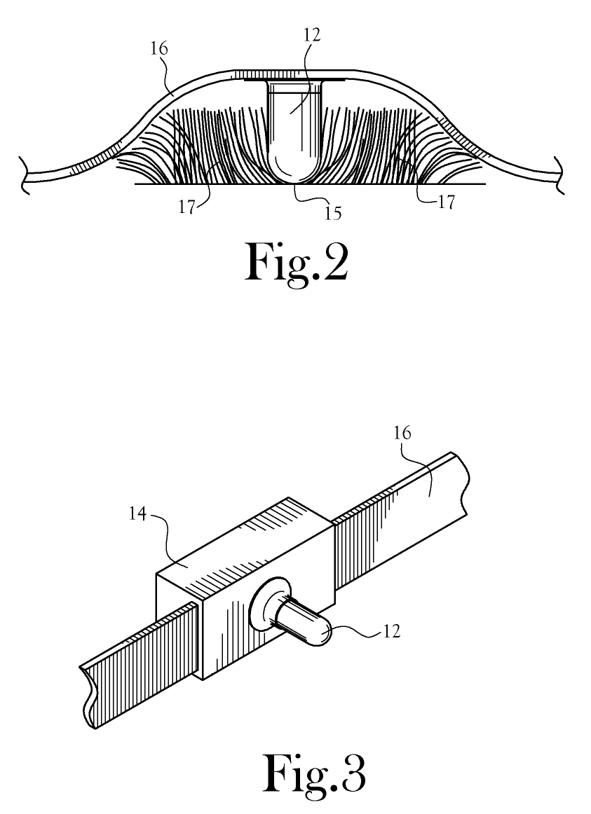

FIG. 1 illustrates one embodiment of the vibration stimulus delivery device 10 in accordance with the various features of the present invention. The vibration stimulus delivery device 10 includes a vibration probe 12, a stimulus trigger detection device 14, and a carrying device 16. The carrying device 16 includes a pet collar, pet harness, or similar apparatus that is adapted to be secured to the animal. In the illustrated embodiment, the carrying device 16 is a pet collar with a buckle. The vibration probe 12 and the stimulus trigger detection device 14 are secured to the carrying device 16, which is secured to the animal such that the animal carries the vibration probe 12 and the stimulus trigger detection device 14. The vibration probe 12 is disposed on the carrying device 16 such that when the carrying device 16 is secured to the animal, the vibration probe 12 is secured in physical contact with the skin of the animal. More specifically, the vibration probe 12 penetrates the animal's fur and physically engages the skin of the animal, as depicted in FIG. 2. In FIG. 2, the animal's skin is represented at 15 and the animal's fur is represented at 17. The vibration probe 12 is secured in physical contact with the animal's skin 15 by the carrying device 16. In the illustrated embodiment, the vibration probe 12 is secured to the inside face of the carrying device 16, namely the face of the carrying device 16 that opens toward the animal, such that the vibration probe 12 is positioned between the carrying device 16 and the animal's skin 15. Because the carrying device 16 is secured snuggly about the animal's neck, the carrying device 16 secures the vibration probe 12 in physical contact with the animal's skin 15 such that the animal's fur 17 parts around the vibration probe 12.

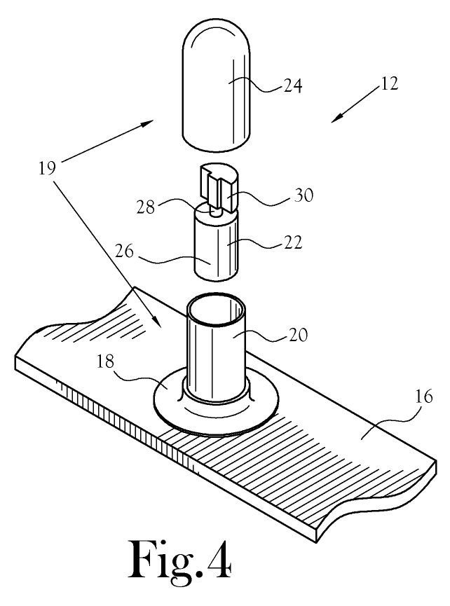

An alternative embodiment of the vibration stimulus delivery device 10 in accordance with the various features of the present invention is illustrated at FIG. 3. The illustrated alternative embodiment includes the vibration probe 12 secured to the stimulus trigger detection device 14 such that the vibration probe 12 extends outwardly therefrom. The stimulus trigger detection device 14 is secured to the carrying device 16 such that the vibration probe 12 is secured in physical contact with the skin of the animal as previously discussed. It should be noted that various configurations of the vibration probe 12, the stimulus trigger detection device 14, and the carrying device 16 are achievable without departing from the scope or spirit of the present invention so long as the vibration probe 12 is secured in physical contact with skin of the animal.

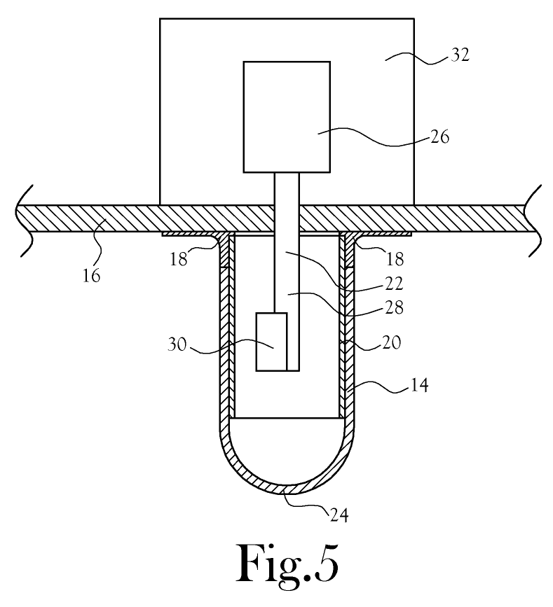

FIG. 4 illustrates one embodiment of the vibration probe 12 in accordance with the various features of the present invention. The vibration probe 12 includes a vibration probe housing 19 and a vibrator 22. In the illustrated embodiment, the vibration probe housing 19 includes a base portion 18, a sheath portion 20, and a casing 24. The base portion 18 is secured to the inside face of the carrying device 16 such that the vibration probe 12 is carried by the animal as discussed above. The sheath portion 20 is secured to the base portion 18 and provides a housing for the vibrator 22, which is disposed within the sheath portion 20. The casing 24 is disposed around the sheath portion 20, encloses the vibrator 22 within the sheath portion 20, and abuts the base portion 18 such that neither the sheath portion 20 nor the vibrator 22 is exposed. The casing 24 is constructed of a material that does not significantly dampen the vibration generated by the vibrator 22. In the illustrated embodiment, the casing 24 is constructed of a moderately rigid rubber. Those skilled in the art will recognize that the casing 24 can be constructed of another material, such as a plastic, without departing from the scope or spirit of the present invention. The casing 24 protects the vibrator 22 from elements such as pet fur and environmental debris. It should be noted that various embodiments of the vibration probe housing 19 are achievable without departing from the scope or spirit of the present invention.

When activated, the vibrator 22 generates a vibration to the extent that the vibration probe housing 19, and consequently the vibration probe 12, vibrates. In the illustrated embodiment, the vibrator 22 includes a motor 26, a shaft 28, and a mass 30. The motor 26 is mechanically engaged with a first end of the shaft 28 such that the motor 26 rotates the shaft 28 about its longitudinal axis. The mass 30 is eccentrically secured to a second end of the shaft 28, which is opposite the first end of the shaft 28. Because the mass 30 is eccentrically secured to the shaft 28, a vibration is generated when the motor 26 rotates the shaft 28. It should be noted that various embodiments of the vibrator 22 are achievable without departing from the scope or spirit of the present invention so long as the vibrator 22 generates the vibration within the vibration probe housing 19.

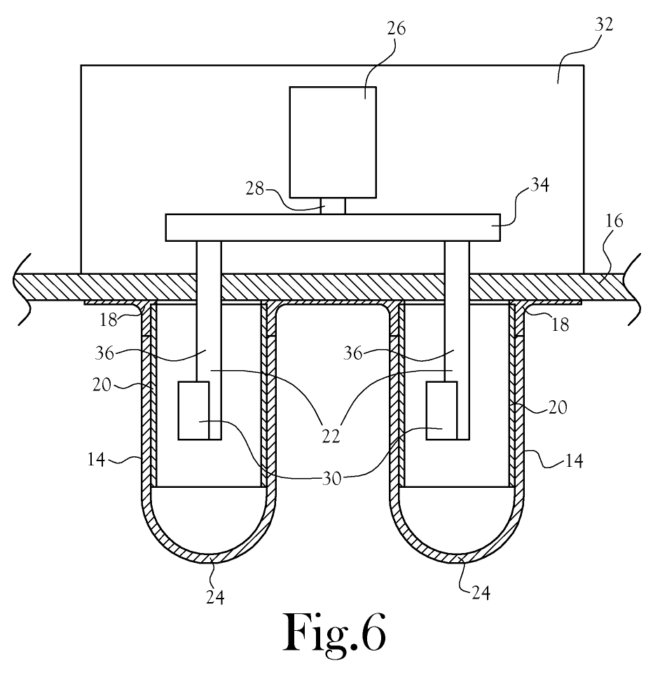

FIG. 5 illustrates an alternative embodiment of the vibrator 22 of the vibration probe 12 in accordance with the various features of the present invention. In the alternative embodiment, the motor 26 is disposed within a motor housing 32, which is secured to the carrying device 16 proximate to the vibration probe 12. In the illustrated embodiment, the motor housing 32 is secured to the carrying device 16 opposite the vibration probe 12 with respect to the carrying device 16. In other words, the motor housing 32 is secured to the outside face of the carrying device 16, and the vibration probe 12 is secured to the inside face of the carrying device 16. The shaft 28, which is mechanically engaged with the motor 26 as discussed above, extends from the motor housing 32, through an opening in the carrying device 16, through the base portion 18, and to the sheath portion 20 such that the mass 30 is eccentrically secured to the shaft 28 within the vibration probe 12. In other words, in this alternative embodiment of the vibrator 22, the motor 26 is not disposed within the vibration probe 12. However, in accordance with the various features of the present invention, the source of the vibration, namely the configured shaft 28 and mass 30, is included within the vibration probe 12.

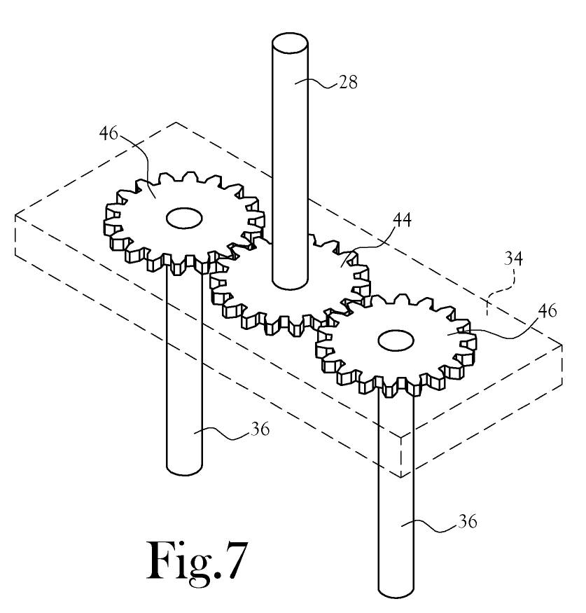

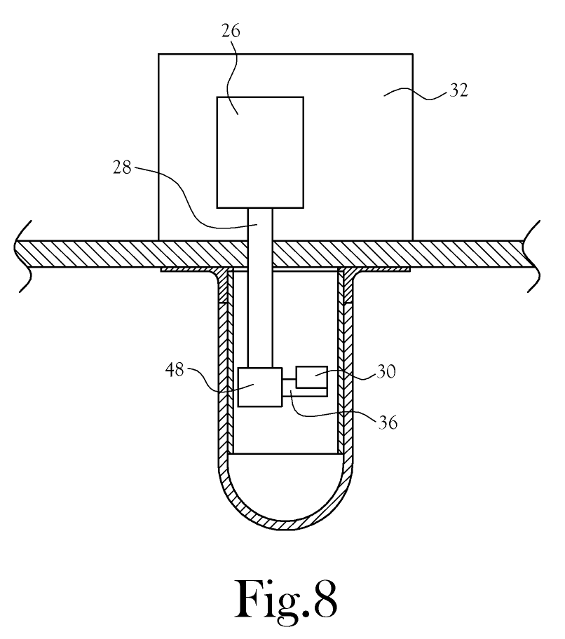

FIG. 6 illustrates another alternative embodiment of the vibrator 22 of the vibration probe 12 in accordance with the various features of the present invention. In this alternative embodiment, the motor 26 and a gearbox 34 are disposed within the motor housing 32. The shaft 28, which is mechanically engaged with the motor 26 at the first end, is mechanically engaged with the gearbox 34 at the second end. The gearbox 34 is mechanically engaged with secondary shafts 36 such that when the motor 26 rotates the shaft 28, the secondary shafts 36 rotate about their respective longitudinal axes. The gearbox 34 of the illustrated embodiment is depicted in FIG. 7. The gearbox 34 includes a primary gear 44 and secondary gears 46. The primary gear 44 is secured to the shaft 28, and the secondary gears 46 are secured to respective secondary shafts 36. The teeth of the primary gear 44 are operably engaged with the teeth of the secondary gears 46 such that when the primary gear 44 is rotated by the shaft 28, the secondary gears 46 rotate, rotating the secondary shafts 36. Those skilled in the art will recognize that the gearbox 34 can be configured in a way other than the illustrated configuration without departing from the scope or spirit of the present invention.

Returning to FIG. 6, each secondary shaft 36 extends from the motor housing 32, through openings in the carrying device 16, through each secondary shaft's 36 respective base portion 18, and to each secondary shaft's 36 respective sheath portion 20 such that each respective mass 30 is eccentrically secured to its respective secondary shaft 36 within each respective vibration probe 12. In other words, in this alternative embodiment of the vibrator 22, a single motor 26 drives two vibration probes 12.

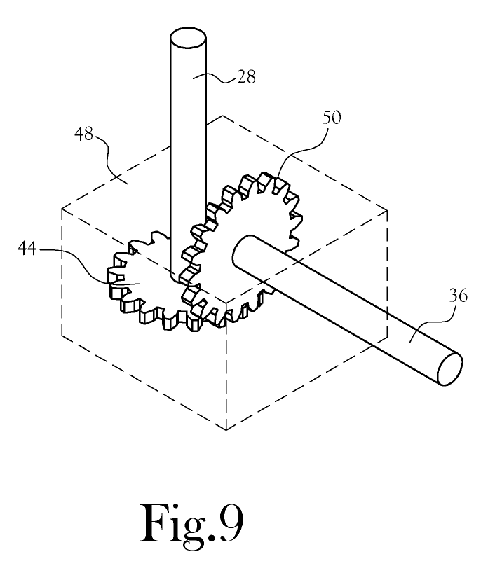

FIG. 8 illustrates an alternative embodiment of the vibrator 22 of the vibration probe 12 in accordance with the various features of the present invention. In this alternative embodiment, the vibrator 22 includes a gearbox 48 disposed within the sheath portion 20. In the illustrated embodiment, the shaft 28, which is mechanically engaged with the motor 26 as discussed above, extends from the motor housing 32, through an opening in the carrying device 16, through the base portion 18, and to the sheath portion 20, where the shaft 28 is mechanically engaged with the gearbox 48. The gearbox 48 is mechanically engaged with a secondary shaft 36 such that the secondary shaft 36 is positioned perpendicular to the shaft 28. As with previous embodiments, the mass 30 is eccentrically secured to the secondary shaft 36. When the motor 26 rotates the shaft 28, the secondary shaft 36 rotates about its longitudinal axis, generating a vibration with a direction that is parallel to the shaft 28 and perpendicular to the skin of the animal.

FIG. 9 illustrates the gearbox 48 of the vibrator 22 illustrated in FIG. 8. The gearbox 48 includes a primary gear 44 and a secondary gear 50. The primary gear 44 is secured to the shaft 28, and the secondary gear 50 is secured to the secondary shaft 36. The teeth of the primary gear 44 are operably engaged with the teeth of the secondary gear 50 such that when the primary gear 44 is rotated by the shaft 28, the secondary gear 50 rotates, rotating the secondary shaft 36. Those skilled in the art will recognize that the gearbox 48 can be configured in a way other than the illustrated configuration without departing from the scope or spirit of the present invention.

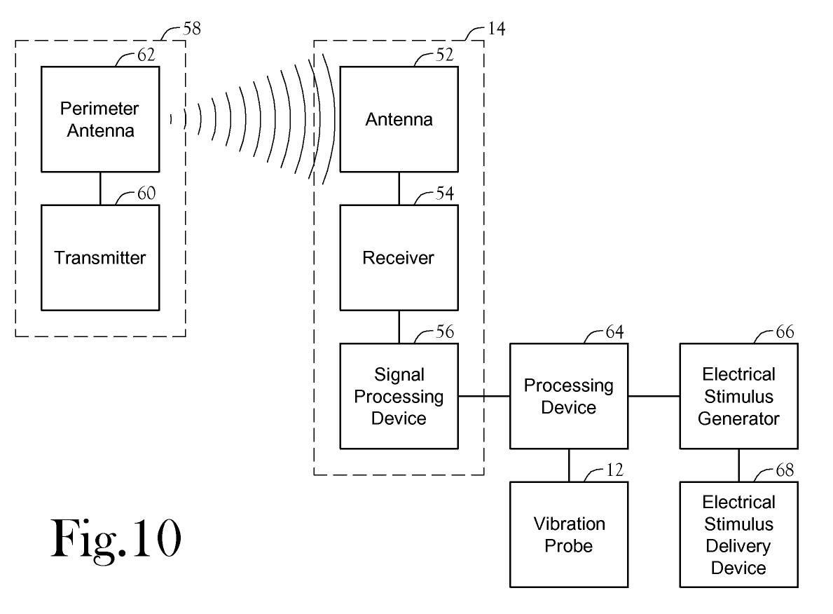

FIG. 10 is a block diagram illustrating various operational features of one embodiment of the vibration stimulus delivery device 10 in accordance with the various features of the present invention. In the illustrated embodiment, the stimulus trigger detection device 14 is a component of an electronic pet confinement system. Consequently, the stimulus trigger is the signal emitted by the perimeter-defining antenna of the electronic pet confinement system. The stimulus trigger detection device 14 includes an antenna 52, a receiver 54, and a signal processing device 56. The receiver 54 is in electrical communication with the antenna 52 and the processing device 56 and is in wireless communication with the signal transmitting portion of the electronic pet confinement system, which is depicted at 58. The signal transmitting portion of the electronic pet confinement system includes a transmitter 60 and a perimeter antenna 62. The perimeter antenna 62 defines the perimeter within which the animal is confined, such as the yard of the animal's owner. The perimeter antenna 62 is in electrical communication with the transmitter 60, which transmits a wireless signal, namely the stimulus trigger, by way of the perimeter antenna 62 such that the wireless signal radiates from the perimeter antenna 62. The receiver 54, by way of the antenna 52, is adapted to receive the wireless signal transmitted by the perimeter antenna 62 when the stimulus trigger detection device 14, which is carried by the animal, approaches the perimeter antenna 62. When the receiver 54 receives the wireless signal from the perimeter antenna 62, the receiver 54 relays the wireless signal to the signal processing device 56. The signal processing device 56 processes the received signal to determine whether the received signal was transmitted by the transmitter 60. When the signal processing device 56, which is in electrical communication with a processing device 64, determines that the received signal was transmitted by the transmitter 60, the signal processing device 56 indicates such to the processing device 64. In other words, the stimulus trigger detection device 14 responds to the stimulus trigger. The processing device 64 then activates the vibration probe 12.

The effect of the vibration stimulus delivery device 10 is that when the animal approaches the perimeter of the electronic pet confinement system defined by the perimeter antenna 62, namely the perimeter of the yard, the vibration stimulus delivery device 10 delivers a vibration stimulus to the animal by way of the vibration probe 12, discouraging the animal from leaving the yard. Because the vibration probe 12 is the source of the vibration and is secured in physical contact with the skin of the animal, the delivered vibration stimulus is effective as a deterrent. However, if the user of the illustrated embodiment of the vibration stimulus delivery system 10 desires to use the vibration stimulus as a warning and a more intense stimulus as the deterrent, the illustrated embodiment includes an electrical stimulus generator 66 in electrical communication with the processing device 64 and an electrical stimulus delivery device 68. When the vibration stimulus delivery system 10 delivers a vibration stimulus to the animal, and the animal continues to approach the perimeter defined by the perimeter antenna 62, the processing device 64 activates the electrical stimulus generator 66, which generates an electrical stimulus that is delivered to the animal by way of the electrical stimulus delivery device 68. The electrical stimulus delivery device 68 includes two electrodes in physical contact with the skin of the animal.

It should be noted that one embodiment of the vibration stimulus delivery device 10 includes the vibration probe 12 as the sole device for delivering a stimulus to the animal. Another embodiment of the vibration stimulus delivery device 10 includes the vibration probe 12 for delivering a vibration stimulus to the animal and another device for delivering a stimulus other than a vibration stimulus to the animal. It should also be noted that various devices for delivering various types of stimuli, such as an electrical or audible stimulus, can be used in combination with the vibration probe 12 without departing from the scope or spirit of the present invention. Additionally, those skilled in the art will recognize that the stimulus trigger detection device 14 can be adapted to communicate with animal training systems other than electronic pet confinement systems without departing from the scope or spirit of the present invention. Those skilled in the art will also recognize that the stimulus trigger detection device 14 can respond to a stimulus trigger other than a signal transmitted by an animal training system without departing from the scope or spirit of the present invention. For example, the stimulus trigger detection device 14 includes a bark detector such as a microphone or a vibration detector such that the stimulus trigger detection device responds to the undesired barking of the animal.

From the foregoing description, those skilled in the art will recognize that a device for delivering an effective vibration stimulus offering advantages over the prior art has been provided. The device provides a vibration probe secured in physical contact with the skin of the animal. Further, the device provides a vibrator disposed within the vibration probe such that the vibration generated by the vibrator transfers effectively to the animal.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A vibration stimulus delivery device for delivering a vibration stimulus to an animal, said vibration stimulus delivery device comprising:
a stimulus trigger detection device, said stimulus trigger detection device responsive to a stimulus trigger, said stimulus trigger detection device adapted to be carried by the animal; and
a vibration probe, said vibration probe including a vibration probe housing and a vibrator, the vibration probe housing adapted to be secured in physical contact with the skin of the animal, the vibrator disposed within the vibration probe housing, said vibration probe in electrical communication with said stimulus trigger detection device such that when said stimulus trigger detection device responds to the stimulus trigger, the vibrator generates a vibration to the extent that said vibration probe vibrates, said vibration probe adapted to be carried by the animal.

2. The vibration stimulus delivery device of claim 1 wherein the stimulus trigger is an electrical signal.

3. The vibration stimulus delivery device of claim 2 wherein the stimulus trigger is a wireless signal.

4. The vibration stimulus delivery device of claim 2 wherein an animal training system generates and transmits the stimulus trigger.

5. The vibration stimulus delivery device of claim 1 wherein the stimulus trigger is a bark from the animal.

6. The vibration stimulus delivery device of claim 1 wherein said vibration probe includes a motor, the motor mechanically engaged with the vibrator of said vibration probe, the motor drives the vibrator such that the vibrator generates a vibration.

7. The vibration stimulus delivery device of claim 6 wherein the motor of said vibration probe is disposed within the vibration probe housing of said vibration probe.

8. The vibration stimulus delivery device of claim 6 further comprising a plurality of the vibrator and a plurality of the vibration probe housing, each of said plurality of the vibrator disposed within each of the plurality of the vibration probe housing respectively, each of said plurality of the vibrator mechanically engaged with the motor, the motor drives each of said plurality of the vibrator such that each of said plurality of the vibrator generates a vibration.

9. The vibration stimulus delivery device of claim 1 wherein the vibrator of said vibration probe includes a mass eccentrically secured to a shaft, the shaft being mechanically engaged with the motor of said vibration probe such that the motor rotates the shaft to the extent that the shaft and the mass generate a vibration.

10. The vibration stimulus delivery device of claim 1 wherein said vibration probe is mechanically secured to said stimulus trigger detection device such that said vibration probe and said stimulus trigger detection device define a structure.

11. The vibration stimulus delivery device of claim 10 further comprising a carrying device, said carrying device adapted to be secured to the animal such that the animal carries said carrying device, said stimulus trigger detection device secured to said carrying device such that the structure defined by said vibration probe and said stimulus trigger detection device is carried by the animal by way of said carrying device.

12. The vibration stimulus delivery device of claim 1 further comprising a carrying device, said carrying device adapted to be carried by the animal, said vibration probe secured to said carrying device such that said vibration probe is carried by the animal when said carrying device is carried by the animal, said stimulus trigger detection device secured to said carrying device such that said stimulus trigger detection device is carried by the animal when said carrying device is carried by the animal.

13. The vibration stimulus delivery device of claim 1 wherein the vibrator of said vibration probe generates a vibration with a direction perpendicular to the skin of the animal.

14. A vibration probe for delivering a vibration stimulus to an animal, said vibration probe comprising:
a vibration probe housing, said vibration probe housing including a base portion and a casing, the base portion adapted to be secured to a carrying device, the casing adapted to be held in physical contact with the skin of the animal, the base portion compatible with the casing such that the base portion and the casing define an interior;
a vibrator, said vibrator disposed within the interior of said vibration housing; and
a motor, said motor disposed within the interior of said vibration housing, said motor mechanically engaged with said vibrator, said motor driving said vibrator such that said vibrator generates a vibration, the vibration generated by said vibrator causing said vibration probe housing to vibrate.

15. The vibration probe of claim 14 wherein said vibration probe is in electrical communication with a stimulus trigger detection device, the stimulus trigger detection device adapted to be secured to the carrying device, the stimulus trigger detection device responsive to a stimulus trigger, said vibration probe generates a vibration when said stimulus trigger device responds to the stimulus trigger.

16. A vibration stimulus delivery device for delivering a vibration stimulus to an animal, said vibration stimulus delivery device comprising:
a carrying device, said carrying device adapted to be secured to the animal;
at least one vibration probe, said at least one vibration probe secured to said carrying device such that said at least one vibration probe is secured in physical contact with the animal's skin, said at least one vibration probe delivers a vibration stimulus to the animal;
an electrical stimulus delivery device, said electrical stimulus delivery device secured to said carrying device, said electrical stimulus delivery device delivers an electrical stimulus to the animal;
a stimulus trigger detection device, said stimulus trigger detection device secured to said carrying device, said stimulus trigger detection device detects a first stimulus trigger and a second stimulus trigger; and
a processing device, said processing device in electrical communication with said at least one vibration probe, said electrical stimulus delivery device, and said stimulus trigger detection device, said processing device determining whether the first stimulus trigger or the second stimulus trigger is detected by said stimulus trigger detection device, said processing device activating said at least one vibration probe when the first stimulus trigger is detected by said stimulus trigger detection device, said processing device activating said electrical stimulus delivery device when the second stimulus trigger is detected by said stimulus trigger detection device.
